(19) United States
(12) Patent Application Publication
(10) Pub. No.: US 2018/0330662 A1
(43) Pub. Date: Nov. 15, 2018

(54) LIGHT-EMITTING SUB-PIXEL CIRCUIT FOR A DISPLAY PANEL, DRIVE METHOD THEREOF, AND DISPLAY PANEL/UNIT USING THE SAME

(71) Applicants: Tadahiko Hirai, (US); Kazunori Ueno, Glen Waverly, Victoria (AU)

(72) Inventors: Tadahiko Hirai, (US); Kazunori Ueno, Glen Waverly, Victoria (AU)

(21) Appl. No.: 15/527,895

(22) PCT Filed: Nov. 20, 2015
(86) PCT No.: PCT/AU2015/050730

§ 371 Date: May 18, 2017

(51) Int. Cl. G09G 3/3258; G09G 3/20

(52) U.S. Cl. CPC G09G 3/3258; G09G 3/2003; G09G 2310/067; G09G 2310/0289; G09G 2310/0251; G09G 3/207

(57) ABSTRACT

A light-emitting sub-pixel circuit for a display panel that allows correction of variations in switching elements and correction of degradation in a three-terminal light-emitting element, a drive method, a display panel using the sub-pixel circuit and method. The light-emitting sub-pixel circuit includes at least two switching elements, at least one capacitor, a three-terminal light-emitting element, a power line for supplying electric power to the three-terminal light-emitting element, a ground line, a scan line for selecting a sub-pixel for light emission, and a data line for supplying data to the three-terminal light-emitting element, each of the power line, the ground line, the scan line, and the data line serving as a conduit for making a connection among the elements wherein data corresponding to a predetermined luminous intensity are programmed on the basis of voltage and a correction voltage different from a programmed voltage is applied to the three-terminal light-emitting element.

### TECHNICAL FIELD

The present invention relates to a light-emitting sub-pixel circuit for a display panel, a drive method thereof, and a display panel/unit using the sub-pixel circuit and, more particularly, to a light-emitting sub-pixel circuit employing a three-terminal light-emitting element, a drive method thereof, and a display panel/unit using the sub-pixel circuit.

### BACKGROUND OF INVENTION

Research and development of a light-emitting transistor that is a three-terminal light-emitting element has progressed in recent years. A light-emitting transistor having a planar structure similar to that of a TFT (Thin Film Transistor) with a linear light-emitting region (see, for example, Patent Literature 1) and a light-emitting transistor having a laminated structure similar to that of a junction type transistor with a greater emission area (see, for example, Patent Literature 2) have been proposed or disclosed. Any of such light-emitting transistors is provided with three terminals; an anode electrode through which a hole is injected, a cathode electrode through which an electron is injected, and a control electrode that controls an electric current (these designations may be different from one disclosure to another).

### CITATION LIST

### Patent Literature

PTL 1: Japanese Unexamined Patent Application Publication No. 2002-246639
PTL 2: Japanese Unexamined Patent Application Publication No. 2005-293980
PTL 3: Japanese Unexamined Patent Application Publication No. 7-57871
PTL 4: Japanese Unexamined Patent Application Publication No. 2007-149922

However, a practical sub-pixel circuit and its drive method for such a three-terminal light-emitting element have not been actually proposed.

FIG. 1 is a diagram showing an exemplary configuration of a sub-pixel circuit employing a conventional three-terminal light-emitting element (see Patent Literature 3). In this configuration, a three-terminal light-emitting element 23 having a gate electrode 2, a source electrode 4, a luminous layer 5, and a transparent electrode 6 provided therein is connected in a simple manner to a matrix wiring consisting of a scanning line 21 and a data line 22. In this sub-pixel configuration, the three-terminal light-emitting element 23 emits light only when the sub-pixel is selected, and no compensation for variation and deterioration in a thin-film transistor 24 and the three-terminal light-emitting element 23 is taken into consideration.

Likewise, FIGS. 2(a) and 2(b) show an exemplary configuration of a sub-pixel circuit employing a conventional three-terminal light-emitting element (see Patent Literature 4). In this configuration, a drive method for programming (writing) a luminous intensity control voltage in a capacitor 185 is disclosed, but no compensation for variation and deterioration in transistors 183, 184 and a three-terminal light-emitting element 140 is taken into consideration.

Meanwhile, displays' requirements for high functionality have been recently becoming more and more stringent. In order to meet these requirements, a display unit taking advantage of many devices must be proposed, along with its drive method.

The present invention may provide a sub-pixel circuit for a display panel employing a three-terminal light-emitting element having a voltage program drive that is capable of high-speed scanning for compensating variation in a switching element and deterioration in the three-terminal light-emitting element, as well as its drive method, and a display panel/unit using the sub-pixel circuit.

A reference herein to a patent document or other matter which is given as prior art is not to be taken as an admission that that document or matter was known or that the information it contains was part of the common general knowledge as at the priority date of any of the claims.

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps or components, or group thereto.

### SUMMARY OF THE INVENTION

According to one aspect of the present invention there is provided a light-emitting sub-pixel circuit for a display panel, comprising at least two switching elements, at least one capacitive element or capacitor, at least one three-terminal light-emitting element, a power line for supplying electric power to the three-terminal light-emitting element, an earth or ground line, a scan line for selecting a sub-pixel for light emission; and a data line for supplying data to the three-terminal light-emitting element, each of the power line, the earth or ground line, the scan line, and the data line serving as a conduit for making a connection among the at least two switching elements, the at least one capacitive element or capacitor, and the at least one three-terminal light-emitting element, wherein data corresponding to a predetermined luminous intensity of the three-terminal light-emitting element is programmed on the basis of voltage and a correction voltage different from a programmed voltage is applied to the three-terminal light-emitting element.

According to another aspect of the present invention there is provided a method for driving a light-emitting sub-pixel circuit for a display panel, including in a drive cycle during which data corresponding to the predetermined luminous intensity of the sub-pixel circuit defined is programmed based on voltage for retention, the further step of applying a correction voltage to the power line after completion of programming.

According to another aspect of the present invention there is provided a display panel comprising a plurality of sub-pixels including the light-emitting sub-pixel circuit as described above arranged in a matrix.

According to another aspect of the present invention there is provided a display unit incorporating a display panel as described above.

The present invention may implement a sub-pixel circuit, its drive method, and a display panel/unit using such a sub-pixel circuit and drive method, which is capable of high-definition and high-speed scanning and correcting variation in switching transistor characteristics and/or deterioration in a three-terminal light-emitting element.

### BRIEF DESCRIPTION OF DRAWINGS

FIG. 1 is a diagram showing an exemplary configuration of a sub-pixel circuit using a conventional three-terminal light-emitting element.

FIG. 2 is a diagram showing an exemplary configuration of a sub-pixel circuit using a conventional three-terminal light-emitting element. FIG. 2(a) is a diagram showing an exemplary configuration of a conventional first sub-pixel circuit. FIG. 2(b) is a diagram showing an exemplary configuration of a conventional second sub-pixel circuit.

FIG. 3 is a diagram showing a first aspect of a light-emitting display unit sub-pixel circuit according to a first embodiment of the present invention.

FIG. 4 is a diagram showing a second aspect of the light-emitting display unit sub-pixel circuit according to the first embodiment of the present invention.

FIG. 5 is a diagram showing a third aspect of the light-emitting display unit sub-pixel circuit according to the first embodiment of the present invention.

FIG. 6 is a diagram showing a fourth aspect of the light-emitting display unit sub-pixel circuit according to the first embodiment of the present invention.

FIG. 7 is a schematic diagram showing the application of voltage with elapse of time in the sub-pixel circuit of FIG. 4. FIG. 7(a) is a diagram showing the application of voltage to a scan line with elapse of time. FIG. 7(b) is a diagram showing the application of data voltage to a three-terminal light-emitting element with elapse of time. FIG. 7(c) is a diagram showing the application of voltage to Point A of FIG. 4 with elapse of time.

FIG. 8 is a diagram showing a first aspect of a light-emitting display unit sub-pixel circuit according to a second embodiment of the present invention.

FIG. 9 is a diagram showing a second aspect of the light-emitting display unit sub-pixel circuit according to the second embodiment of the present invention.

FIG. 10 is a diagram showing a third aspect of the light-emitting display unit sub-pixel circuit according to the second embodiment of the present invention.

FIG. 11 is a diagram showing a fourth aspect of the light-emitting display unit sub-pixel circuit according to the second embodiment of the present invention.

FIG. 12 is a schematic diagram showing the application of voltage with elapse of time in the sub-pixel circuit of FIG. 8. FIG. 12(a) is a diagram showing the application of voltage to a scan line with elapse of time. FIG. 12(b) is a diagram showing the application of data voltage to a three-terminal light-emitting element with elapse of time. FIG. 12(c) is a diagram showing the application of voltage to Point A of FIG. 8 with elapse of time. FIG. 12(d) is a diagram showing the application of voltage to a correction line with elapse of time.

FIG. 13 is a diagram showing a first aspect of a light-emitting display unit sub-pixel circuit according to a third embodiment of the present invention.

FIG. 14 is a diagram showing a second aspect of the light-emitting display unit sub-pixel circuit according to the third embodiment of the present invention.

FIG. 15 is a diagram showing a third aspect of the light-emitting display unit sub-pixel circuit according to the third embodiment of the present invention.

FIG. 16 is a diagram showing a fourth aspect of the light-emitting display unit sub-pixel circuit according to the third embodiment of the present invention.

FIG. 17 is a schematic diagram showing the application of voltage with elapse of time in the sub-pixel circuit of FIG. 13. FIG. 17(a) is a diagram showing the application of voltage to a scan line with elapse of time. FIG. 17(b) is a diagram showing the application of data voltage to a three-terminal light-emitting element with elapse of time. FIG. 17(c) is a diagram showing the application of voltage to Point A of FIG. 13 with elapse of time. FIG. 17(d) is a diagram showing voltage waveforms of detected voltage in a sense line with elapse of time.

FIG. 18 is a diagram showing a sub-pixel circuit whose sense line is connected to a sensing unit.

FIG. 19 is a diagram showing a voltage at various locations with elapse of time. FIG. 19(a) is a diagram showing the application of voltage to a scan line with elapse of time. FIG. 19(b) is a diagram showing the application of data voltage to a three-terminal light-emitting element with elapse of time. FIG. 19(c) is a diagram showing the application of voltage to Point A of FIG. 18 with elapse of time. FIG. 19(d) is a diagram showing the application of voltage to a correction line with elapse of time. FIG. 19(e) is a diagram showing voltage waveforms of detected voltage in a sense line with elapse of time.

FIG. 20 is a diagram showing the configuration of a sensing unit that is different from that of FIG. 18.

FIG. 21 is an exemplary look-up table showing a relationship between a voltage (program bias) at Point A and a control electrode voltage of a three-terminal light-emitting element and a relationship between a control electrode voltage of a three-terminal light-emitting element 10 and luminescence characteristics. FIG. 21(a) is an exemplary look-up table for voltage programs. FIG. 21(b) is an exemplary look-up table for a three-terminal light-emitting element.

FIG. 22 is a diagram showing an example of a light-emitting display panel and a light-emitting display unit according to one embodiment of the present invention.

FIG. 23 is a diagram showing another example of a light-emitting display panel and a light-emitting display unit according to one embodiment of the present invention.

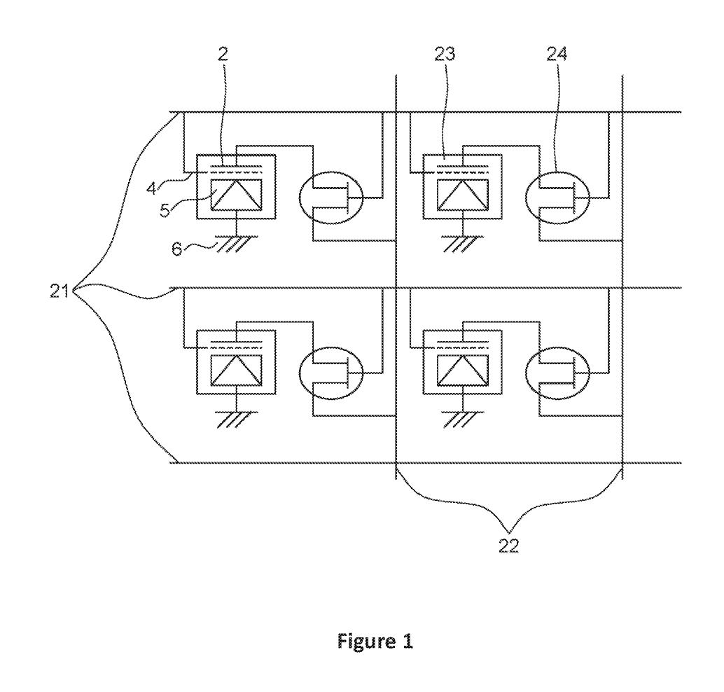

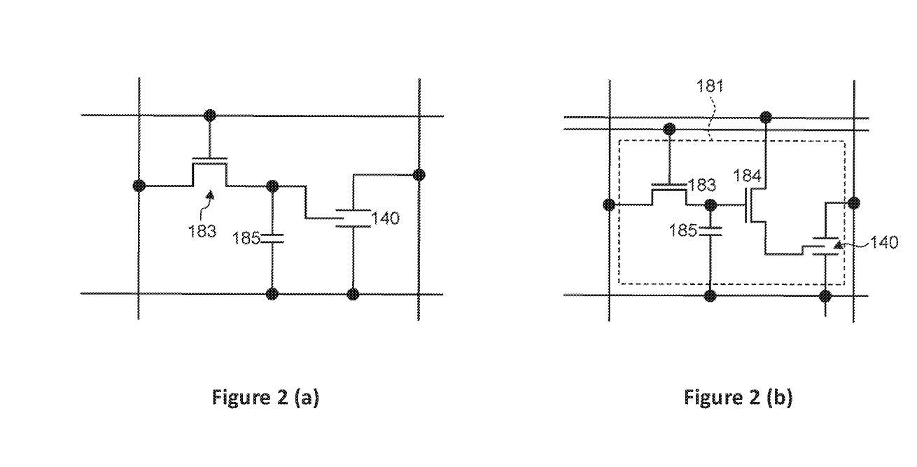

### DETAILED DESCRIPTION

An embodiment according to the present invention will be described below with reference to the attached drawings.

### First Embodiment

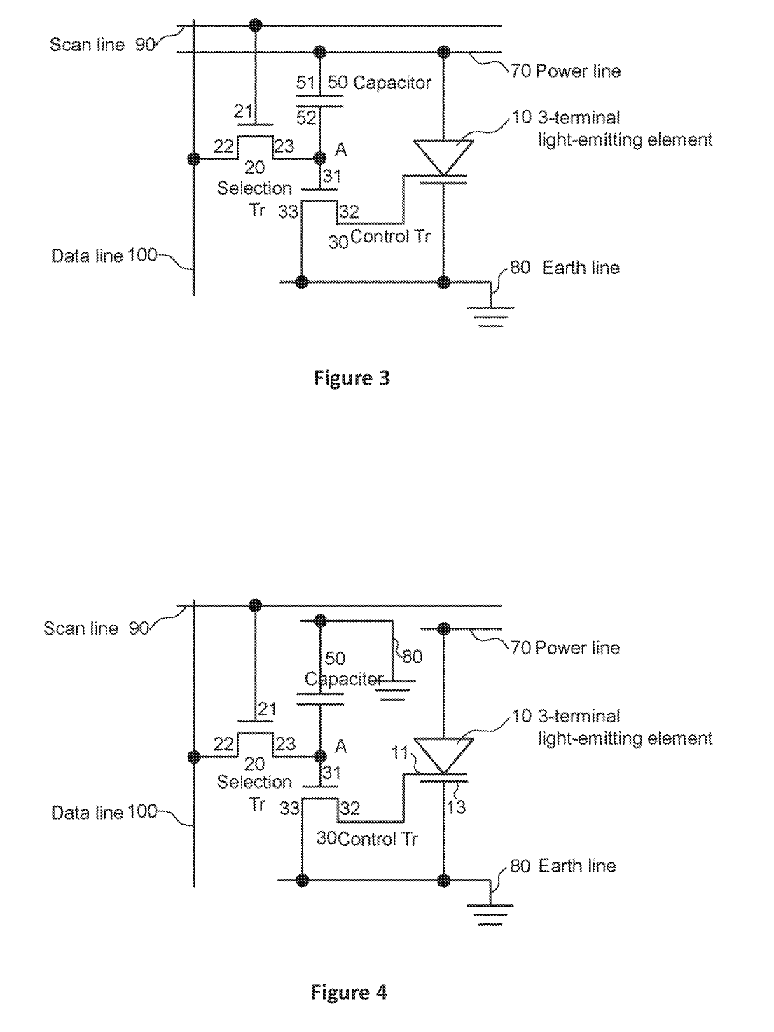

FIGS. 3 through 6 are diagrams showing various aspects of a light-emitting sub-pixel circuit for a display unit according to a first embodiment of the present invention. In the first embodiment, one sub-pixel consists of one three-terminal light-emitting element 10, two n-channel TFTs 20, 30, one or two capacitor(s) 50, 60, which are connected to a power line 70, a ground line 80, a scan line 90, and a data line 100.

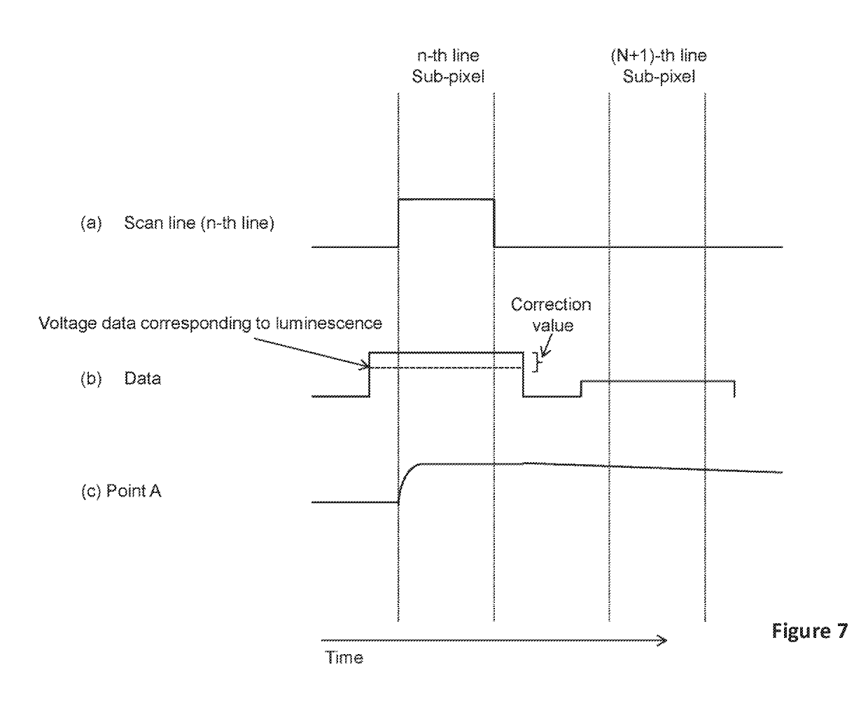

Meanwhile, FIG. 7 is a schematic diagram showing the application of voltage with elapse of time in the sub-pixel circuit of FIG. 4, which is relevant to the time during which data voltage is supplied to sub-pixel circuits in an n-th line and (n+1)-th line in a light-emitting display panel where a sub-pixel circuit shown in FIG. 4 is arranged in a matrix. FIG. 7(a) shows the application of voltage to the scan line 90 with elapse of time. FIG. 7(b) shows the application of data voltage to the three-terminal light-emitting element 10 with elapse of time. FIG. 7(c) shows the application of voltage to Point A of FIG. 4 as time passes. “Point A” of FIG. 7(c) corresponds to Point A of a wire or conduit connected to a gate 31 of the control transistor 30 of FIG. 4, showing the gate voltage of the control transistor 30 with elapse of time.

As shown in FIG. 4, the control transistor 30 has a drain electrode 32 connected to a control electrode 11 of the three-terminal light-emitting element 10 and has a source electrode 33 connected to the ground line 80. The three-terminal light-emitting element 10 has a cathode electrode 13 connected to the ground line 80. The control transistor 30 also has a gate electrode 31 connected to one electrode 52 of a capacitor 50 and to a source electrode 23 of the selection transistor 20. The selection transistor 20 also has a gate electrode 21 connected to the scan line 90 and has a drain electrode 22 connected to the data line 100. The other electrode 51 of the capacitor 50 is connected to the ground line 80.

The three-terminal light-emitting element 10 is a light-emitting element that emits light at levels of luminescence corresponding to levels of voltage applied across an anode electrode 12 and the cathode electrode 13 or levels of current flowing through the anode electrode 12 and the cathode electrode 13, and its luminescence level is controlled by the current or potential of the control electrode 11. The control transistor 30 is a transistor for adjusting luminous intensity of the three-terminal light-emitting element 10. The selection transistor 20 is a transistor for selecting a sub-pixel that is driven to emit light.

The power line 70 is a wire for supplying electric power to a sub-pixel circuit. The ground line 80 is a wire for grounding circuit elements contained in the sub-pixel circuit. The scan line 90 is a wire for selecting a sub-pixel. Supplying the scan line 90 with a selection voltage that activates the selection transistor 20 allows the selection of a sub-pixel to be driven for light emission. The data line 100 is a wire for supplying data (current or voltage) to the three-terminal light-emitting element 10. The luminescence of the three-terminal light-emitting element 10 is controlled by the level of this voltage.

When a voltage is applied to the scan line 90 and to the gate 21 of the selection transistor 20, the selection transistor 20 becomes activated, causing a data signal (voltage) applied to the data line 100 to be applied to the gate electrode (point A) 31 of the control transistor 30. This results in a predetermined level of current flowing to the three-terminal light-emitting element 10, causing the three-terminal light-emitting element 10 to emit light with luminescence corresponding to the data signal (voltage). When no voltage is applied to the scan line 90, the selection transistor 20 becomes deactivated, but the gate voltage (point A) of the control transistor 30 is maintained at a constant level by the capacitor 50 until the next application of a scan voltage.

Meanwhile, voltage obtained by adding (or subtracting) a correction voltage to (or from) the data signal (voltage) of FIG. 7 can be applied to the gate 31 of the control transistor 30. This causes the current flowing through the three-terminal light-emitting element 10 to be increased or lowered by the degree corresponding to the correction voltage.

Degradation in luminous intensity of the three-terminal light-emitting element 10 caused by its deterioration may tend to cause increased resistance due to the accumulation of an electric charge on the interface between luminous layers, resulting in variation in voltage required for passing a predetermined level of current through the control electrode 11 of the three-terminal light-emitting element 10. If this occurs, the three-terminal light-emitting element 10 cannot produce a desired level of luminous intensity even if it is supplied with a control current corresponding to a predetermined level of data voltage (namely, luminous intensity is degraded).

As described above, the sub-pixel circuit according to the first embodiment ensures that a predetermined luminous intensity is produced by causing a correction voltage to be superimposed on the data voltage even if deterioration in the three-terminal light-emitting element 10 results in variation in voltage that is required to produce a predetermined luminous intensity.

FIG. 4 shows a sub-pixel circuit that slightly differs from that shown in FIG. 4 in that one electrode 51 of the capacitor 50 is connected to the power line 70, instead of the ground line 80, and there is no other difference in circuit configuration and sub-pixel circuit operation between the sub-pixel circuits shown in FIG. 4.

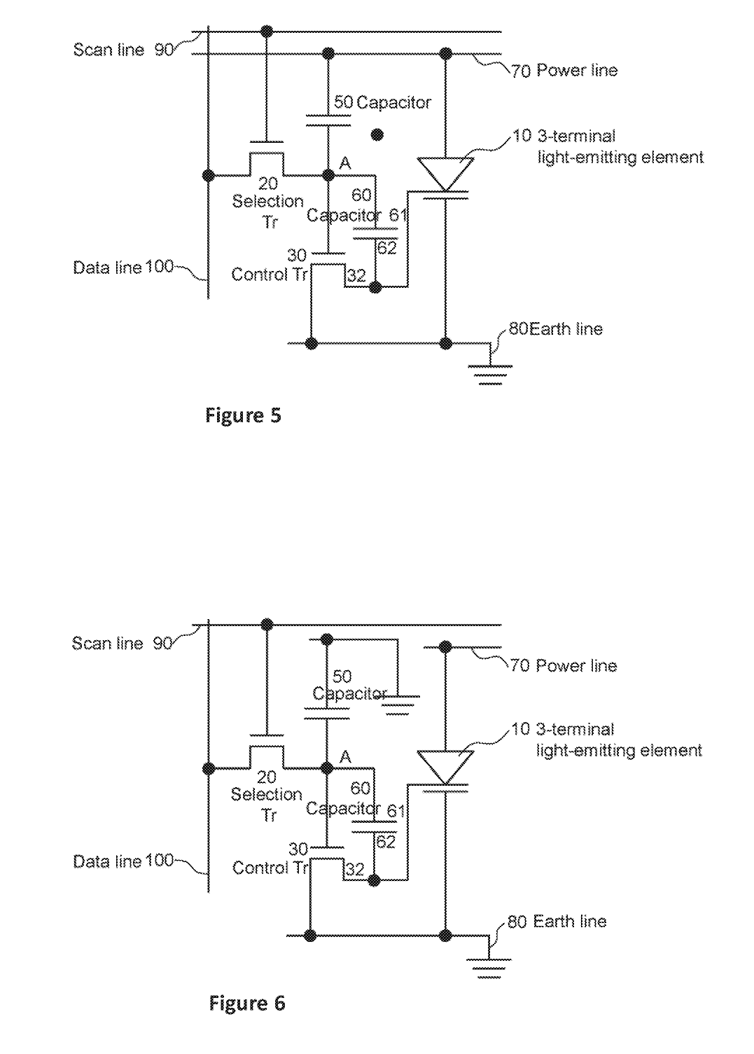

FIGS. 5 and 6 show sub-pixel circuits, each having two capacitors 50, 60 with one electrode 61 of the capacitor 60 connected to Point A and the other electrode 62 connected to the drain electrode 32 of the control transistor 30, giving an additional function for correcting variation in threshold voltage of the control transistor 30. FIG. 5 shows a sub-pixel circuit of FIG. 3 with the capacitor 60 added. FIG. 6 shows a sub-pixel circuit of FIG. 4 with the capacitor 60 added.

The sub-pixel circuit shown in FIGS. 5 and 6 accommodates voltage variation resulting from deterioration in the three-terminal light-emitting element 10 as well as variation in threshold voltage of the control transistor 30, producing a predetermined luminous intensity despite such voltage variations.

### Second Embodiment

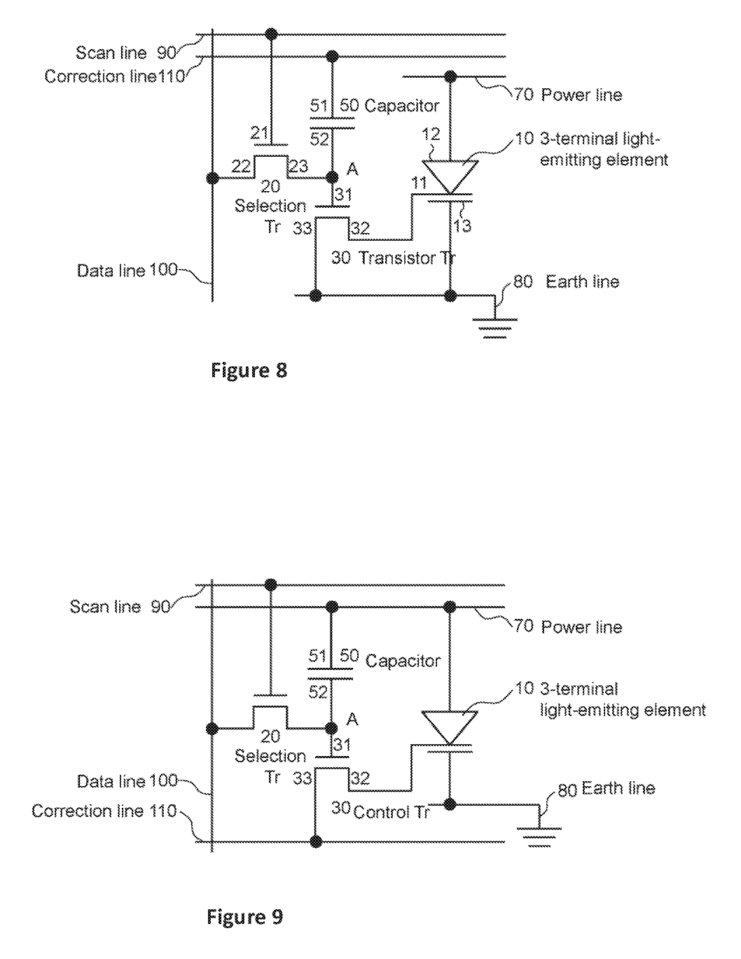

FIGS. 8 through 11 are diagrams showing various aspects of a light-emitting display unit sub-pixel circuit according to a second embodiment of the present invention. In the second embodiment, one sub-pixel consists of two n-channel transistors 20, 30, one or two capacitor(s) 50, 60, one three-terminal light-emitting element 10, which are connected to a power line 70, a ground line 80, a scan line 90, a data line 100, and a correction line 110.

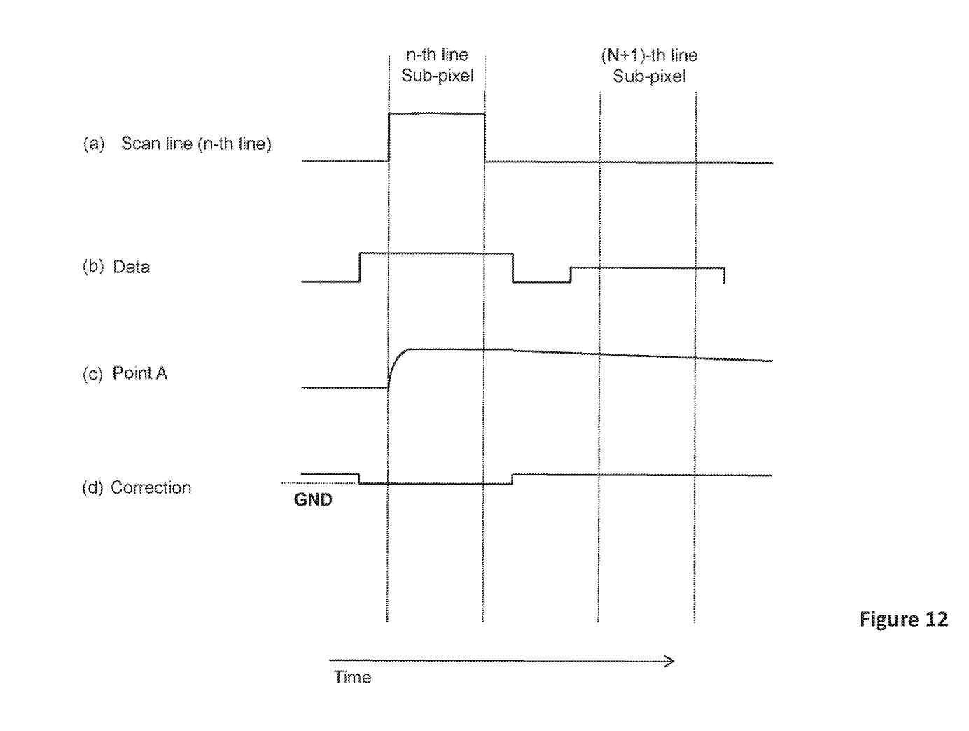

Meanwhile, FIG. 12 is a schematic diagram showing the application of voltage with elapse of time in the sub-pixel circuit of FIG. 8, which is relevant to the time during which data voltage is supplied to sub-pixel circuits in an n-th line and (n+1)-th line in a light-emitting display panel where the sub-pixel circuit shown in FIG. 8 is arranged in a matrix. FIG. 12(a) shows the application of voltage to the scan line 90 with elapse of time. FIG. 12(b) shows the application of data voltage to the three-terminal light-emitting element 10 with elapse of time. FIG. 12(c) shows the application of voltage to Point A of FIG. 8 with elapse of time. “Point A” of FIG. 12(c) corresponds to Point A of a wire connected to a gate 31 of the control transistor 30 of FIG. 8, showing the gate voltage of the control transistor 30 with elapse of time. FIG. 12(d) shows the application of voltage to the correction line 110 with elapse of time.

As shown in FIG. 8, the control transistor 30 has a source electrode 33 connected to the ground line 80 and has a drain electrode 32 connected to a control electrode 11 of the three-terminal light-emitting element 10. The three-terminal light-emitting element 10 has an anode electrode 12 connected to the power line 70 and has a cathode electrode 13 connected to the ground line 80. The control transistor 30 also has a gate electrode 11 connected to one electrode 52 of the capacitor 50 and to a source electrode 23 of the selection transistor 20. The selection transistor 20 also has a gate electrode 21 connected to the scan line 90 and has a drain electrode 22 connected to the data line 100. The other electrode 51 of the capacitor 50 is connected to the correction line 110.

When a voltage is applied to the scan line 90 and to the gate 21 of the selection transistor 20, the selection transistor 20 becomes activated, causing a data signal (voltage) applied to the data line 100 to be applied to the gate electrode (point A) 31 of the control transistor 30. This results in a predetermined level of current flowing to the control electrode 11 of the three-terminal light-emitting element 10, causing the three-terminal light-emitting element 10 to emit light with luminescence corresponding to the data signal (voltage). When no voltage is applied to the scan line 90, the selection transistor 20 becomes deactivated, but the gate voltage (point A) of the control transistor 30 is maintained at a constant level by the capacitor 50 until the next application of a scan voltage.

Meanwhile, voltage obtained by adding (or subtracting) a correction signal (voltage) of FIG. 12(d) to (or from) the correction line can be applied to the gate 31 of the control transistor 30. This causes the current flowing through the three-terminal light-emitting element 10 to be increased or lowered by the degree corresponding to the correction voltage.

Degradation in luminous intensity of the three-terminal light-emitting element 10 caused by its deterioration may tend to cause increased resistance due to the accumulation of an electric charge on the interface between luminous layers, resulting in variation in voltage required for passing a predetermined level of current through the control electrode 11 of the three-terminal light-emitting element 10. If this occurs, the three-terminal light-emitting element 10 cannot produce a desired level of luminous intensity even if it is supplied with a control current corresponding to a predetermined level of data voltage (namely, luminous intensity is degraded).

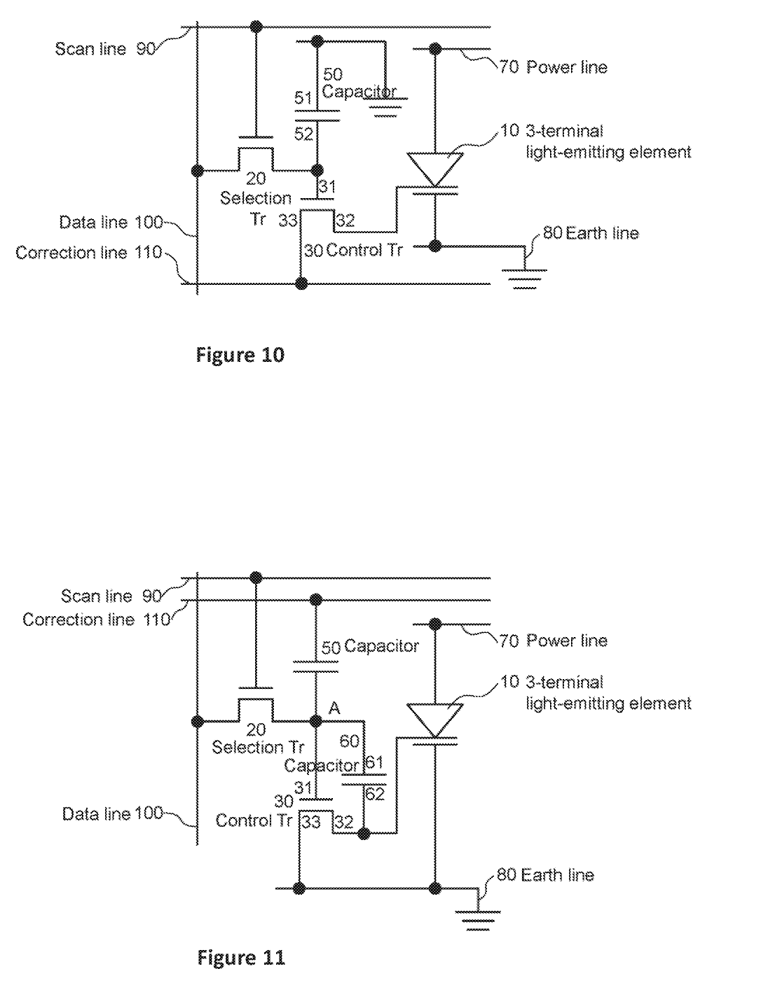

In FIGS. 9 and 10, supplying the correction voltage to the source electrode 33 of the control transistor 30 increases or lowers an electric current flowing through the control electrode 11 of the three-terminal light-emitting element 10 by the degree corresponding to the correction voltage.

FIG. 9 is a diagram showing a sub-pixel circuit that slightly differs from that shown in FIG. 8 in that one electrode 51 of the capacitor 50 is connected to the power line 70 instead of to the correction line 110, and that the source electrode 33 of the control transistor 30 is connected to the correction line 110 instead of to the ground line, and there is no other difference in circuit configuration between the sub-pixel circuits shown in FIG. 8. Also, there is no difference in sub-pixel circuit operation between the sub-pixel circuits shown in FIG. 8, except that the correction voltage is applied to the gate electrode 31 of the control transistor 30 or to the source electrode 33 of the control transistor 30.

FIG. 10 shows a sub-pixel circuit that slightly differs from that shown in FIG. 9 in the electrode 51 of the capacitor 50 is connected to the ground line 80, instead of to the power line 70, and there is no other difference in circuit configuration and sub-pixel circuit operation between the sub-pixel circuits shown in FIG. 9.

FIG. 11 shows a sub-pixel circuit having two capacitors 50, 60 with one electrode 61 of the capacitor 60 connected to Point A and the other electrode 62 connected to the drain electrode 32 of the control transistor 30, giving an additional function for correcting variation in threshold voltage of the control transistor 30. The sub-pixel circuit shown in FIG. 11 accommodates voltage variation resulting from deterioration in the three-terminal light-emitting element 10 as well as variation in threshold voltage of the control transistor 30, producing a predetermined luminous intensity despite such voltage variations.

### Third Embodiment

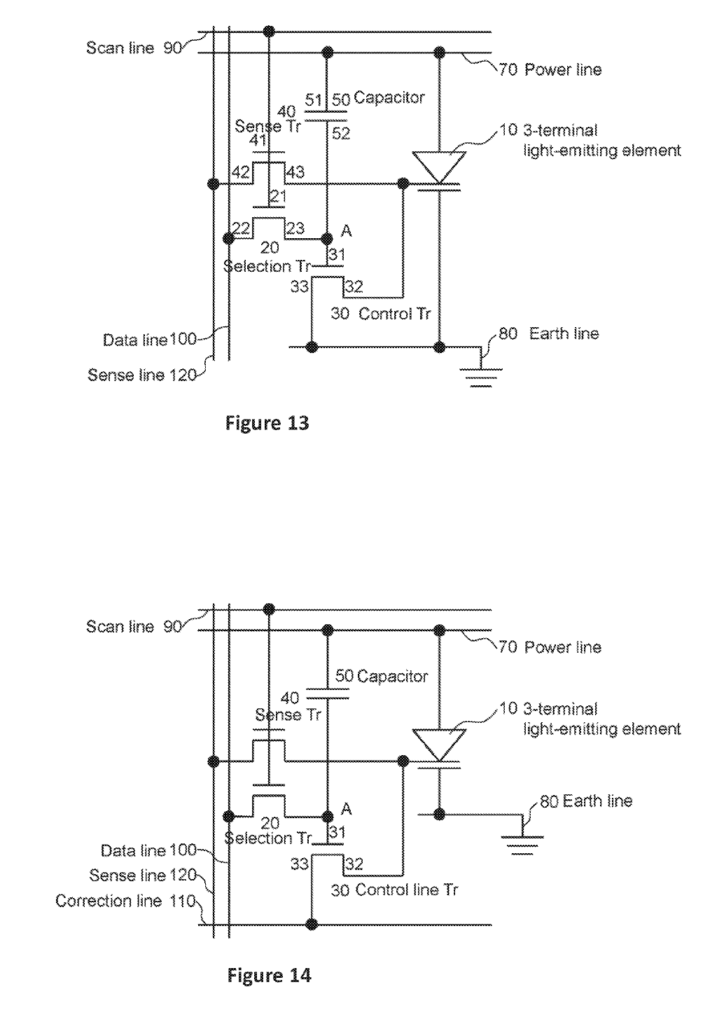

FIGS. 13 through 16 are diagrams showing various aspects of a light-emitting display unit sub-pixel circuit according to a third embodiment of the present invention. In the third embodiment, one sub-pixel consists of three n-channel transistors 20, 30, 40, one or two capacitor(s) 50, 60, and one three-terminal light-emitting element 10, which are connected to a power line 70, a ground line 80, a scan line 90, a data line 100, a correction line 110, and a sense line 120.

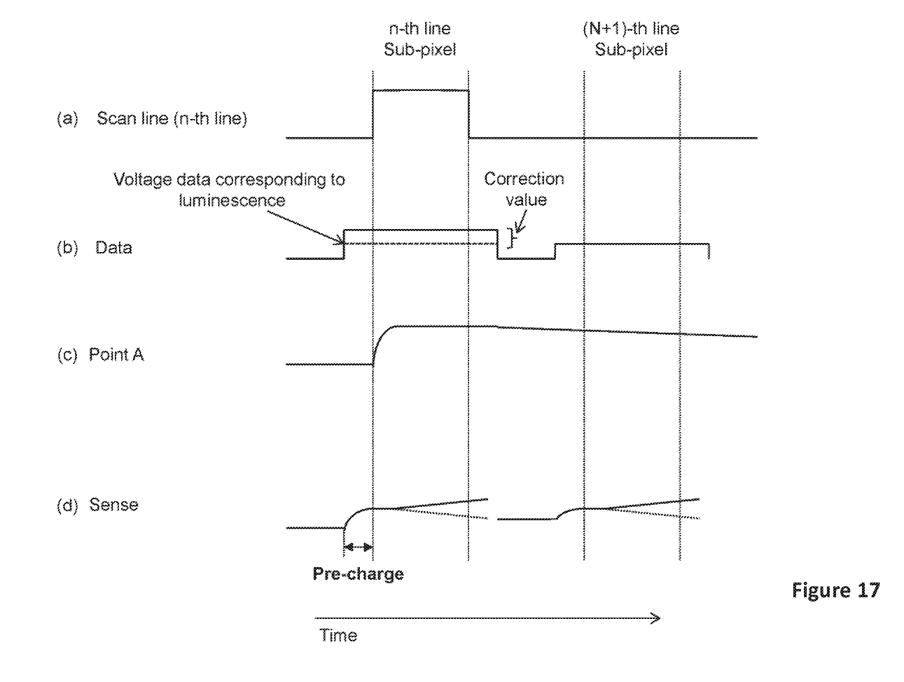

Meanwhile, FIG. 17 is a schematic diagram showing the application of voltage with elapse of time in the sub-pixel circuit of FIG. 13. FIG. 17 is relevant to the time during which data voltage is supplied to sub-pixel circuits in an n-th line and (n+1)-th line in a light-emitting display panel where the sub-pixel circuit shown in FIG. 13 is arranged in a matrix. FIG. 17(a) shows the application of voltage to the scan line 90 with elapse of time. FIG. 17(b) shows the application of data voltage to the three-terminal light-emitting element 10 with elapse of time. FIG. 17(c) shows the application of voltage to Point A of FIG. 13 with elapse of time. “Point A” of FIG. 13 corresponds to Point A of a wire connected to a gate 31 of the control transistor 30 of FIG. 13, showing the gate voltage of the control transistor 30 with elapse of time. FIG. 17(d) shows the waveform of a detected voltage in the sense line 120.

As shown in FIG. 13, the control transistor 30 has a source electrode 33 connected to the ground line 80 and has a drain electrode 32 connected to a control electrode 11 of the three-terminal light-emitting element 10. The three-terminal light-emitting element 10 has an anode electrode 12 connected to the power line 70 and has a cathode electrode 13 connected to the ground line 80. The control transistor 30 also has the gate electrode 31 connected to one electrode 52 of the capacitor 50 and to a source electrode 23 of the selection transistor 20. The selection transistor 20 also has a gate electrode 21 connected to the scan line 90 and has a drain electrode 22 connected to the data line 100. The other electrode 51 of the capacitor 50 is connected to the power line 70. The sense transistor 40 has a gate electrode 41 connected to the scan line 90, has a drain electrode 42 connected to the sense line 120, and has a source electrode 43 connected to the control electrode 11 of the three-terminal light-emitting element 10.

When a voltage is applied to the scan line 90 and to the gate of the selection transistor 20, the selection transistor 20 and the sense transistor 40 become activated, causing a data signal (voltage) applied to the data line 100 to be applied to the gate electrode (point A) 31 of the control transistor 30. This results in a predetermined level of current flowing to the control electrode 11 of the three-terminal light-emitting element 10, causing the three-terminal light-emitting element 10 to emit light with luminescence corresponding to the data signal (voltage). At the same time, the control electrode 11 of the three-terminal light-emitting element 10 is connected to the sense line 120 through the sense transistor 40, resulting in a comparison between the potential of the sense line 120 and that of the control electrode 11 of the three-terminal light-emitting element 10.

When no voltage is applied to the scan line 90, the selection transistor 20 becomes deactivated, but the gate voltage (point A) of the control transistor 30 is maintained at a constant level by the capacitor 50 until the next application of a scan voltage.

Meanwhile, voltage obtained by adding (or subtracting) a correction signal (voltage) of FIG. 17 to (or from) an original data signal can be applied to the gate 31 of the control transistor 30. This causes the current flowing through the three-terminal light-emitting element 10 to be increased or lowered by the degree corresponding to the correction voltage.

Degradation in luminous intensity of the three-terminal light-emitting element 10 caused by its deterioration may tend to cause increased resistance due to the accumulation of an electric charge on the interface between luminous layers, resulting in variation in voltage required for passing a predetermined level of current through the control electrode 11 of the three-terminal light-emitting element 10. If this occurs, the three-terminal light-emitting element 10 cannot produce a desired level of luminous intensity even if it is supplied with a control current corresponding to a predetermined level of data voltage (namely, luminous intensity is degraded).

Meanwhile, the sense line 120 is charged at a predetermined level of potential before the sense transistor 40 becomes activated, and experiences potential variation when the sense transistor 40 becomes activated. Detection of a direction of such variation allows determination to be made as to whether the potential of the control electrode 11 of the three-terminal light-emitting element 10 is higher or lower than a predetermined level of potential.

Basic operation is the same as that of the sub-pixel circuit shown in FIG. 8.

FIG. 14 is a diagram showing a sub-pixel circuit that slightly differs from that shown in FIG. 13 in that the source electrode 32 of the control transistor 30 is connected to the correction line 110, instead of to the ground line 80. The pixel circuit shown in FIG. 14 has the correction line 110 provided, to which a correction voltage is applied.

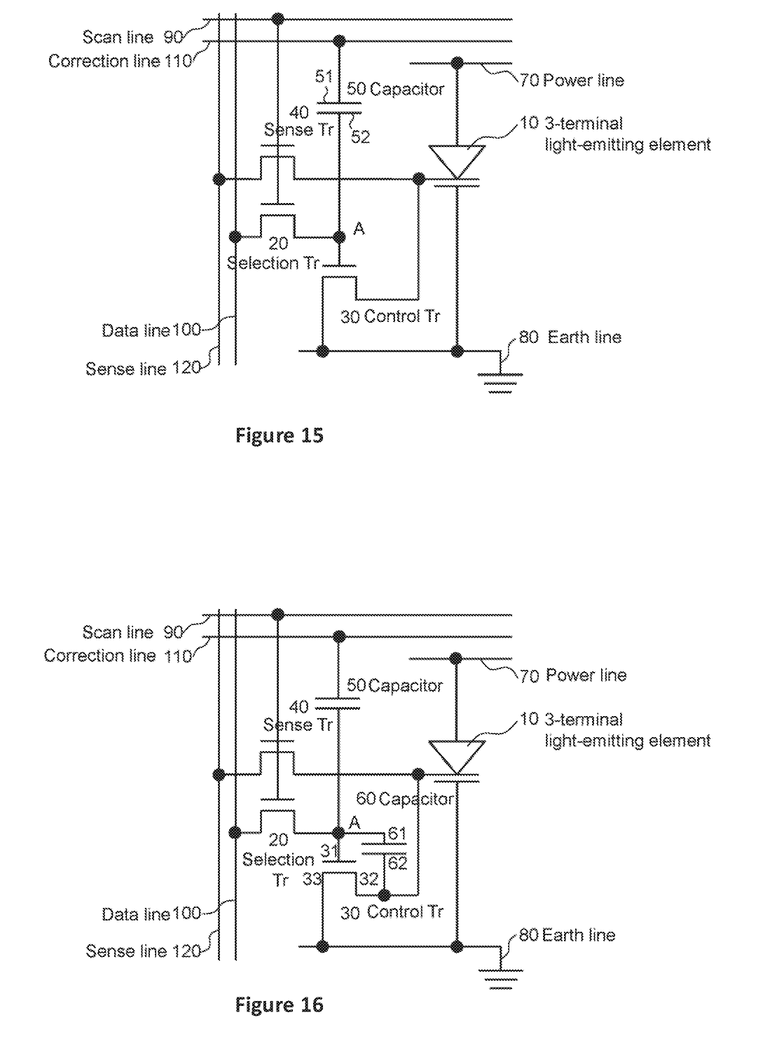

FIG. 15 is a diagram showing a sub-pixel circuit that slightly differs from that shown in FIG. 14 in that the source electrode 32 of the control transistor 30 is connected to the ground line 80, instead of to the correction line 110, and that the electrode 51 of the capacitor 50 is connected to the correction line 110, instead of to the power line 70. In the sub-pixel circuit shown in FIG. 15, a correction voltage is applied to the correction line 110.

FIG. 16 shows a sub-pixel circuit having two capacitors 50, 60 with one electrode 61 of the capacitor 60 connected to Point A and the other electrode 62 connected to the drain electrode 32 of the control transistor 30, giving an additional function for correcting variation in threshold voltage of the control transistor 30. The sub-pixel circuit shown in FIG. 16 accommodates voltage variation resulting from deterioration in the three-terminal light-emitting element 10 as well as variation in threshold voltage of the control transistor 30, producing a predetermined luminous intensity despite such voltage variations.

### Fourth Embodiment

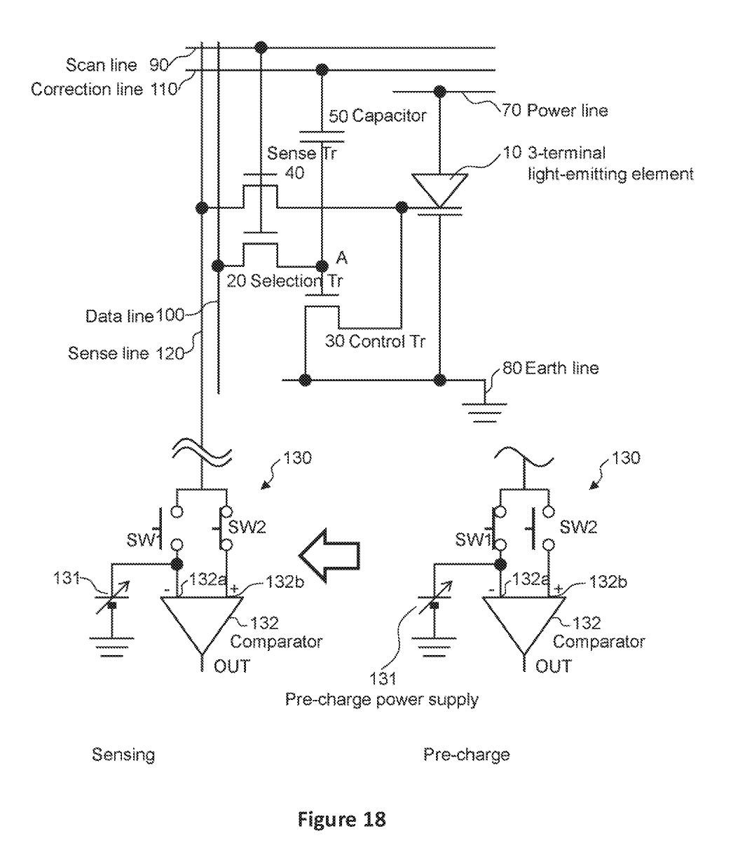

FIG. 18 is a diagram showing the sub-pixel circuit described above whose sense line 120 is connected to a sensing unit 130. The sub-pixel circuit shown in FIG. 18 is the same as that shown in FIG. 15, except for the sensing unit 130. The reference numerals and symbols in FIG. 18 refer to the same components as those with the same reference numerals and symbols in FIG. 15, and repeated descriptions of the same components are omitted.

In the sub-pixel circuit shown in FIG. 18, the sense line 120 and one terminal (inverted terminal 132a of FIG. 6) of a comparator are charged in advance (or pre-charged) at a voltage set by a pre-charge power supply 131 in order to measure the voltage of the control electrode 11 of the three-terminal light-emitting element 10. Such a pre-charge corresponds to a state shown in the lower right of FIG. 18 in which switches SW1, SW2 are turned on and off, respectively, and the voltage set by the pre-charge power supply 131 is applied to the inverted terminal of 132a of the comparator 132.

Next, when a voltage is applied to the scan line 90, the selection transistor 20 and the sense transistor 40 become activated, causing the sense line 120 to be electrically connected to the control electrode 11 of the three-terminal light-emitting element 10. This results in the switches 1, 2 being off and on, respectively, as shown in the lower left of FIG. 18. At this time, if the voltage at the control electrode of the three-terminal light-emitting element 10 is lower than the pre-charge voltage, the potential of the sense line 120 lowers slightly, causing a low voltage to be output from the comparator 132 through the process of the comparison of potential across the comparator 132. In contrast, if the voltage at the control electrode of the three-terminal light-emitting element 10 is higher than the pre-charge voltage, the potential of the sense line 120 increases slightly, causing a high voltage to be output from the comparator 132 through the process of the comparison of potential across the comparator 132.

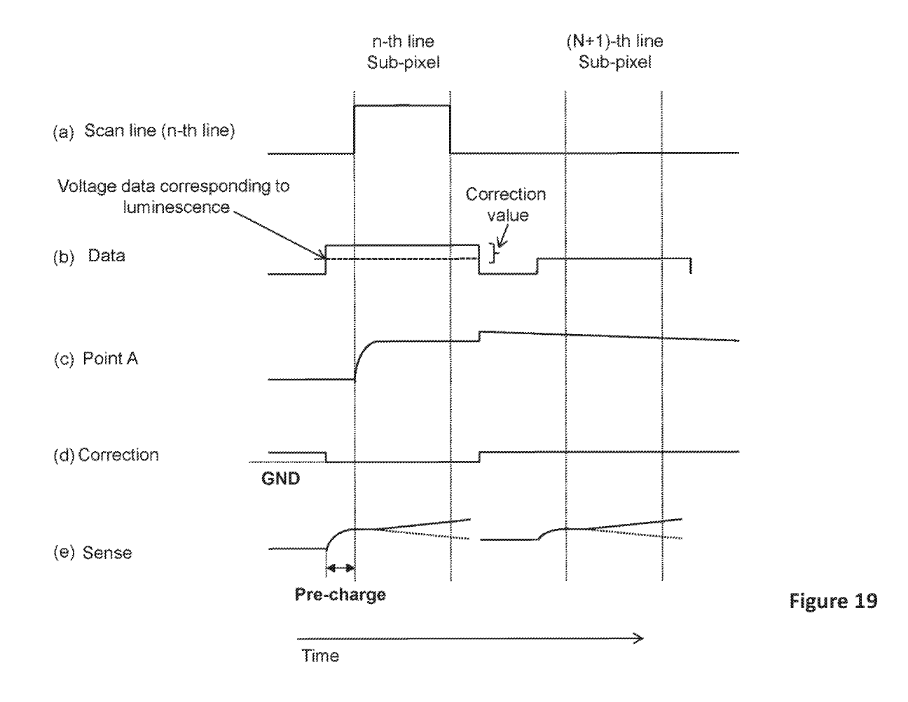

FIG. 19 is a schematic diagram showing the potential at various points as time passes. FIG. 19 is relevant to the time during which data voltage is supplied to sub-pixel circuits in an n-th line and (n+1)-th line in a light-emitting display panel where a sub-pixel circuit shown in FIG. 18 is arranged in a matrix. FIG. 19(a) shows the application of voltage to the scan line 90 with elapse of time. FIG. 19(b) shows the application of data voltage to the three-terminal light-emitting element 10 with elapse of time. FIG. 19(c) shows the application of voltage to Point A of FIG. 18 with elapse of time. FIG. 19(d) shows the application of voltage to the correction line 110 with elapse of time. FIG. 19(e) shows the waveform of a detected voltage in the sense line 120.

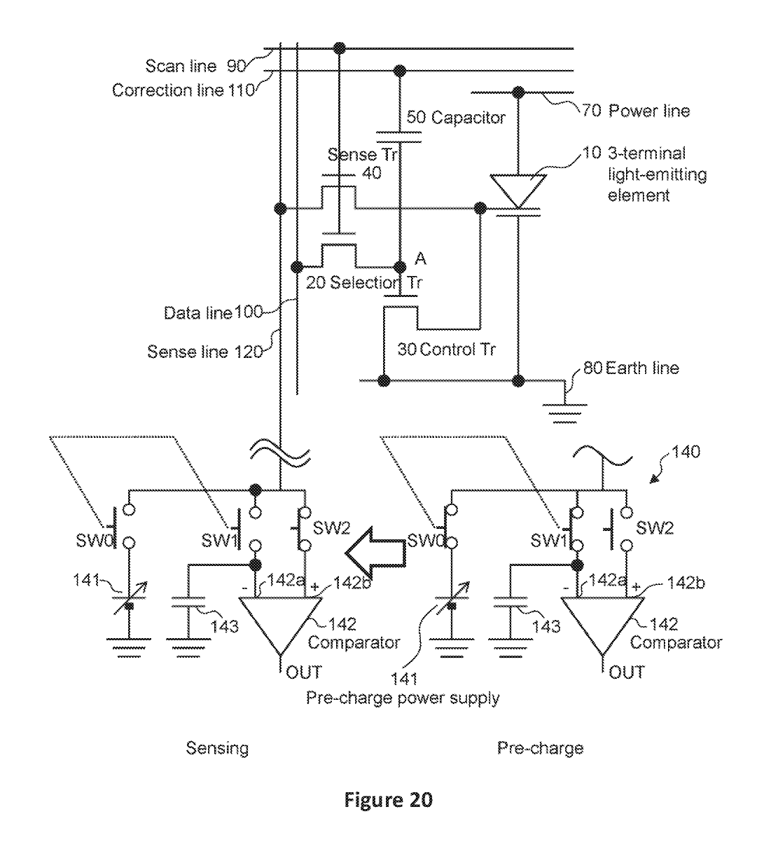

FIG. 20 is a diagram showing the configuration of a sensing unit 140 that is different from that of FIG. 18. The sensing unit 140 is the same as that of FIG. 18 in that a switch is connected to the non-inverted terminal of a comparator 142, but differs from that of FIG. 18 in that a capacitor 143 and a switch SW1 are connected to the inverted terminal 142a, and that a pre-charge power supply 141 and a switch SW0 are connected in parallel to them.

With this arrangement, during a pre-charge mode, a voltage set by the pre-charge power supply 141 is applied to the inverted terminal 142a of the comparator 142 and such a pre-charge voltage is maintained by the capacitor 143 in the sensing unit 140, as shown in the lower right of FIG. 20.

When performing sensing operation, the sensing unit 140 is switched to a state shown in the lower left of FIG. 20, in which the scan line 120 is energized to activate the selection transistor 20 and the sense transistor 40. This causes a voltage applied to the data line 100 to be applied to the control electrode 11 of the three-terminal light-emitting element 10 through the control transistor 30. At this time, the sense transistor 40 has been activated and the sense line 120 has been pre-charged at a pre-charge-voltage set by the pre-charge power supply 141, which causes a voltage at the control electrode of the three-terminal light-emitting element 10 to be input to a non-inverted terminal 142b of the comparator 142 through the sense line 120, resulting in a comparison with the pre-charge voltage. If the voltage at the control electrode of the three-terminal light-emitting element 10 is higher than the pre-charge voltage, a high level of voltage signal is output from the comparator 142, from which an increase in the voltage at the control electrode of the three-terminal light-emitting element 10 is detected.

As described above, the sensing unit 140 may have a configuration shown in FIG. 20. Also, the sensing unit 140 is not limited in configuration to these embodiments and may have various other configurations if it is capable of detecting variations in the control electrode voltage of the three-terminal light-emitting element 10.

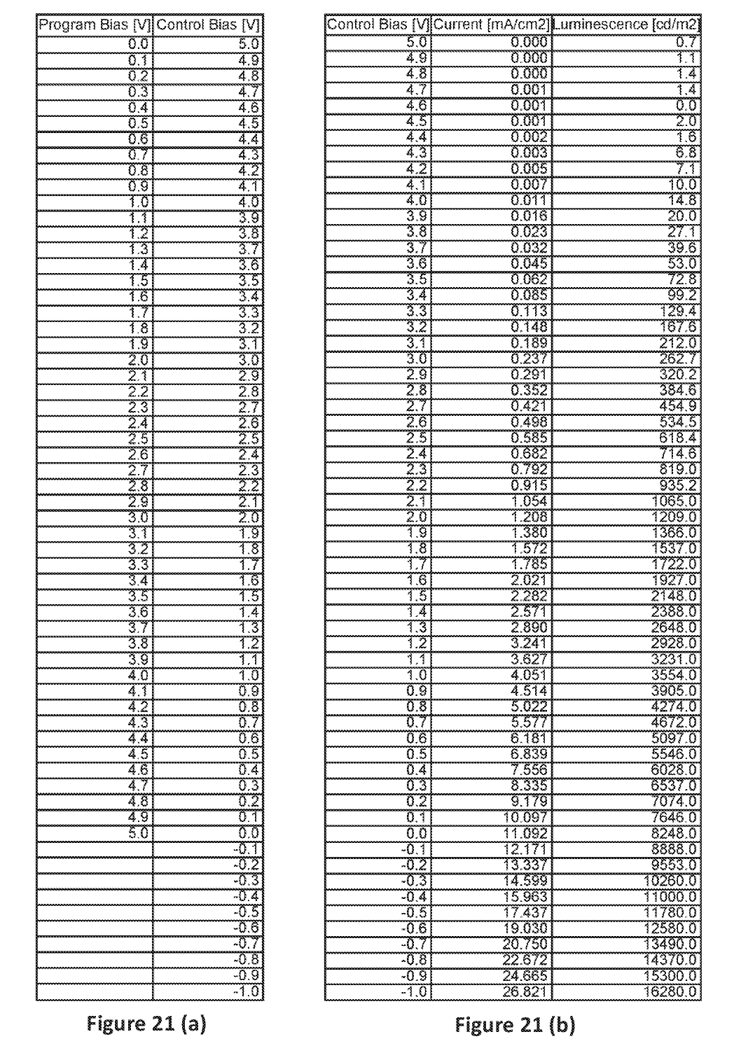

FIG. 21 is an exemplary look-up table showing a relationship between a voltage (program bias) at Point A and a control electrode voltage of a three-terminal light-emitting element and a relationship between a control electrode voltage of a three-terminal light-emitting element 10 and luminescence characteristics.

As an example, a case where the three-terminal light-emitting element 10 is operated to produce luminescence of about 1,000 cd/m2 is assumed. From FIG. 21(b), control electrode voltage corresponding to about 1,000 cd/m2 is set at 2.10 V. From FIG. 21(a), program bias is set at 2.90 V. Then, the sense line 120 is pre-charged at 2.10 V, which corresponds to the control electrode voltage.

A high signal output from the comparators 132, 142 at the first scanning would indicate that the pre-charge voltage is lower than the control electrode voltage of the three-terminal light-emitting element 10, despite the gate electrode 31 of the control transistor 30 being charged at 2.1 V. Then, the pre-charge voltage is increased by one step (+0.1 V in this case) before the second scanning is performed.

If the pre-charge voltage at 2.5 V provides a low output from the comparators 132, 142 for the first time (after four repeated attempts to scan), the gate electrode voltage of the control transistor 30 would be expected to increase by 19% and the control electrode voltage of the three-terminal light-emitting element to decrease by about 14%.

As described above, when variations in gate electrode voltage of the control transistor 30 detected via the sense line 120 increase in the positive direction (or on the upward trend), the pre-charge voltage may be likewise increased by one step in the positive direction (or on the upward trend) before the variations in gate electrode voltage of the control transistor 30 are detected again by means of the sense line 120. The number of steps required for voltage correction can be determined by repeating the above operation until the voltage variations are changed to decrease in the negative direction (or on the downward trend). This enables luminescence correction (or luminous intensity correction) based on proper voltage corrections. Although in this example voltage variations in the positive direction or on the upward trend are described, the same operation can also be performed for cases where voltage variations decrease in the negative direction or on the downward trend. In other words, the pre-charge voltage is changed by the proper number of steps in the negative direction corresponding to voltage variations of the gate electrode 31 of the control transistor 30, thereby enabling luminescence correction (or luminous intensity correction) based on proper voltage corrections.

There are two options for compensating for the decrease in luminescence. One of the options can be accomplished by changing the voltage settings for the gate electrode 31 of the control transistor 30 from 2.1 V to 2.5 V. The second option can be accomplished by pixel scanning followed by applying +0.4 V to the correction line to increase the gate voltage of the control transistor 30 through the capacitor 50. In this case, the look-up table for the control transistor 30 does not need to be updated.

The look-up table may be stored in a predetermined storage element, such as nonvolatile memory or ROM (read only memory). Data, pre-charge voltages, and correction voltages corresponding to a predetermined luminescence may be determined by referencing the look-up table stored in such a storage element.

Also, there is a method for mathematically calculating application voltages without using the look-up table. The mathematical models can be stored in a predetermined storage element, such as nonvolatile memory or ROM. Data, pre-charge voltages, and correction voltages corresponding to a predetermined luminescence may be calculated by referencing the mathematical models stored in such a storage element.

A light-emitting display panel sub-pixel circuit and its drive method described in the embodiments 1 through 4 can be applied to a display panel and display unit employing such a sub-pixel circuit and its drive method. A light-emitting display panel can be configured by arranging in matrix a plurality of pixels each having a light-emitting display panel sub-pixel circuit. In addition, a light-emitting display unit or light-emitting display system can be configured using an image processing circuit, a control circuit, and an enclosure.

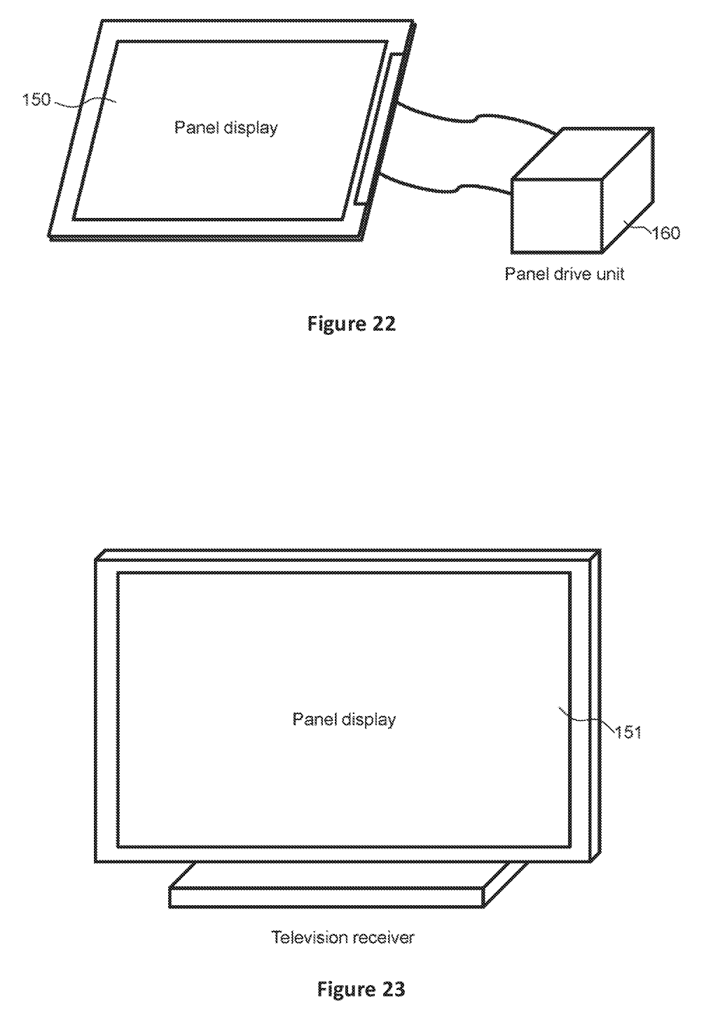

FIG. 22 is a diagram showing an example of a light-emitting display panel and a light-emitting display unit according to one embodiment of the present invention. Although a panel display unit 150 and a panel drive unit 160 are shown in FIG. 22, the panel display unit 150 is constructed of a plurality of sub-pixels described in embodiments 1 through 4 arranged in matrix. The panel drive unit 160 is a unit for driving the panel display unit 150 constructed as a light-emitting display panel and is provided with various image processing circuits required for displaying an image. With this arrangement, a light-emitting display unit is implemented.

FIG. 23 is a diagram showing another example of a light-emitting display panel and a light-emitting display unit according to one embodiment of the present invention. FIG. 23 shows an example of a light-emitting display unit having a panel display unit 151 constituting a light-emitting display panel incorporated into a television receiver.

As described above, a light-emitting display panel and a light-emitting display unit may be constructed using a sub-pixel circuit and its drive method according to embodiments 1 through 4.

Typical configurations of the present invention are described with reference to, but are not limited to, the foregoing preferred embodiments. Various modifications are conceivable within the scope of the present invention.

### REFERENCE SIGNS LIST

10 Three-terminal light-emitting element
20-40 Transistor (Switching element)
50, 60, 143 Capacitor
70 Power line
80 Ground line
90 Scan line
100 Data line
110 Correction line
120 Sense line
130, 140 Sensing unit
150, 151 Panel display unit
160 Panel drive unit

1.-33. (canceled)

34. A light-emitting sub-pixel circuit for a display panel, comprising:
at least two switching elements;
at least one capacitor;
at least one three-terminal light-emitting element;
a power line for supplying electric power to the three-terminal light-emitting element;
a ground line;
a scan line for selecting a sub-pixel for light emission; and
a data line for supplying data to the three-terminal light-emitting element,
wherein each of the power line, the ground line, the scan line, and the data line is configured to serve as a conduit for making a connection among the at least two switching elements, the at least one capacitor, and the at least one three-terminal light-emitting element, and
wherein the light-emitting sub-pixel circuit is configured such that the three terminal light-emitting element receives (i) data corresponding to a predetermined luminous intensity of the three-terminal light-emitting element on the basis of a programmed voltage, and (ii) a correction voltage different from the programmed voltage.

35. The light-emitting sub-pixel circuit according to claim 34, further comprising a sensing unit for sensing a control electrode voltage of the three-terminal light-emitting element.

36. The light-emitting sub-pixel circuit according to claim 34, wherein the conduit further includes a correction line.

37. The light-emitting display panel sub-pixel circuit according to claim 34, wherein the conduit further includes a sense line.

38. The light-emitting sub-pixel circuit according to claim 34, wherein the at least two switching elements are a field effect transistor which includes an active layer composed mainly of silicon, metallic oxide, or organic matter.

39. The light-emitting sub-pixel circuit according to claim 34, wherein the at least two switching elements are an n-channel field effect transistor or include a p-channel field effect transistor.

40. The light-emitting sub-pixel circuit according to claim 34,
wherein the at least two switching elements comprise a control transistor for controlling emission of the three-terminal light-emitting element and a selection transistor for selecting a sub-pixel for light emission;
wherein the three-terminal light-emitting element has an anode connected to the power line and has a cathode connected to the ground line;
wherein the control transistor has a first main electrode connected to a control electrode of the three-terminal light-emitting element and has a second main electrode connected to the ground line;
wherein the selection transistor has a first main electrode connected to the data line and has a second main electrode connected to a control electrode of the control transistor and to a first electrode of the capacitor;
wherein the capacitor has a second electrode connected to the power line or ground line; and
wherein the selection transistor has a control electrode connected to the scan line.

41. The light-emitting sub-pixel circuit according to claim 40, further comprising a second capacitor inserted between a node of the first main electrode of the control transistor and the control electrode of the three-terminal light-emitting element and a node of the second main electrode of the selection transistor, the control electrode of the control transistor, and the first electrode of the capacitor.

42. The light-emitting sub-pixel circuit according to claim 36,
wherein the at least two switching elements comprise a control transistor for controlling emission of the three-terminal light-emitting element and a selection transistor for selecting a sub-pixel for light emission;
wherein the three-terminal light-emitting element has an anode connected to the power line and has a cathode connected to the ground line;
wherein the control transistor has a first main electrode connected to a control electrode of the three-terminal light-emitting element and has a second main electrode connected to the ground line;
wherein the selection transistor has a first main electrode connected to the data line and has a second main electrode connected to a control electrode of the control transistor and to a first electrode of the capacitor;
wherein the capacitor has a second electrode connected to the correction line; and
wherein the selection transistor has a control electrode connected to the scan line.

43. The light-emitting sub-pixel circuit according to claim 42, further comprising a second capacitor inserted between a node of the first main electrode of the control transistor and the control electrode of the three-terminal light-emitting element and a node of the second main electrode of the selection transistor, the control electrode of the control transistor, and the first electrode of the capacitor.

44. The light-emitting sub-pixel circuit according to claim 36,
wherein the at least two switching elements comprise a control transistor for controlling emission of the three-terminal light-emitting element and a selection transistor for selecting a sub-pixel for light emission;
wherein the three-terminal light-emitting element has an anode connected to the power line and has a cathode connected to the ground line;
wherein the control transistor has a first main electrode connected to control electrode of the three-terminal light-emitting element and has a second main electrode connected to the correction line;
wherein the selection transistor has a first main electrode connected to the data line and has a second main electrode connected to a control electrode of the control transistor and to a first electrode of the capacitor;
wherein the capacitor has a second electrode connected to the power line or the ground line; and
wherein the selection transistor has a control electrode connected to the scan line.

45. The light-emitting sub-pixel circuit according to claim 37,
wherein the at least two switching elements comprise a control transistor for controlling emission of the three-terminal light-emitting element, a selection transistor for selecting a sub-pixel for light emission, and a sense transistor for taking a sense signal;
wherein the three-terminal light-emitting element has an anode connected to the power line and has a cathode connected to the ground line;
wherein the control transistor has a first main electrode connected to a control electrode of the three-terminal light-emitting element and has a second main electrode connected to the ground line;
wherein the selection transistor has a first main electrode connected to the data line and has a second main electrode connected to a control electrode of the control transistor and to a first electrode of the capacitor;
wherein the sense transistor has a first main electrode connected to a control electrode of the three-terminal light-emitting element and a second main electrode connected to the sense line;
wherein the capacitor has a second electrode connected to the power line or the ground line; and
wherein the selection transistor and the sense transistor have a control electrode connected to the scan line.

46. The light-emitting sub-pixel circuit according to claim 37,
wherein the at least two switching elements comprise a control transistor for controlling emission of the three-terminal light-emitting element, a selection transistor for selecting a sub-pixel for light emission, and a sense transistor for taking a sense signal;
wherein the conduit includes the correction line;
wherein the three-terminal light-emitting element has an anode connected to the power line and has a cathode connected to the ground line;
wherein the control transistor has a first main electrode connected to the control electrode of the three-terminal light-emitting element and has a second main electrode connected to the correction line;
wherein the selection transistor has a first main electrode connected to the data line and has a second main electrode connected to a control electrode of the control transistor and to a first electrode of the capacitor;
wherein the sense transistor has a first main electrode connected to a control electrode of the three-terminal light-emitting element and a second main electrode connected to the sense line;
wherein the capacitor has a second electrode connected to the power line or the ground line; and
wherein the selection transistor and the sense transistor have a control electrode connected to the scan line.

47. The light-emitting sub-pixel circuit according to claim 37,
wherein the at least two switching elements comprise a control transistor for controlling emission of the three-terminal light-emitting element, a selection transistor for selecting a sub-pixel for light emission, and a sense transistor for taking a sense signal;
wherein the conduit includes the correction line;
wherein the three-terminal light-emitting element has an anode connected to the power line and has a cathode connected to the ground line;
wherein the control transistor has a first main electrode connected to the control electrode of the three-terminal light-emitting element and has a second main electrode connected to the ground line;
wherein the selection transistor has a first main electrode connected to the data line and has a second main electrode connected to a control electrode of the control transistor and to a first electrode of the capacitor;
wherein the sense transistor has a first main electrode connected to a control electrode of the three-terminal light-emitting element and a second main electrode connected to the sense line;
wherein the capacitor has a second electrode connected to the correction line; and
wherein the selection transistor and the sense transistor have a control electrode connected to the scan line.

48. The light-emitting sub-pixel circuit according to claim 47, further comprising a second capacitor inserted between a node of the first main electrode of the control transistor and the control electrode of the three-terminal light-emitting element and a node of the second main electrode of the selection transistor, the control electrode of the control transistor, and the first electrode of the capacitor.

49. A method comprising:
providing the light-emitting sub-pixel circuit according to claim 40;
performing a drive cycle during which the data corresponding to the predetermined luminous intensity of the three-terminal light-emitting element is programmed based on voltage for retention; and
applying the correction voltage to the power line after completion of the programming.

50. A method comprising:
providing the light-emitting sub-pixel circuit according to claim 42,
performing a drive cycle during which the data corresponding to the predetermined luminous intensity of the three-terminal light-emitting element is programmed based on voltage for retention; and
applying the correction voltage to the correction line after completion of the programming.

51. A method comprising:
providing a light-emitting sub-pixel circuit according to claim 45,
pre-charging the sense line at a predetermined pre-charge voltage;
detecting voltage variations in the sense line;
performing a drive cycle during which the data corresponding to the predetermined luminous intensity of the three-terminal light-emitting element is programmed based on voltage for retention; and
applying a correction voltage to the power line after completion of the programming.

52. A method comprising:
providing a light-emitting sub-pixel circuit according to claim 46;
pre-charging the sense line at a predetermined pre-charge voltage;
detecting voltage variations in the sense line;
applying a correction voltage to the correction line after completion of the programming.

53. The method according to claim 51, wherein, if the voltage variations in the sense line are found to be in a positive or negative direction, the pre-charge voltage is changed by one predetermined step in the same direction as the positive or negative direction before the voltage variations are detected again.
